(19) United States
(12) Patent Application Publication
(10) Pub. No.: US 2016/0034996 A1
(43) Pub. Date: Feb. 4, 2016

(54) SYSTEMS AND METHODS FOR FACILITATING REAL ESTATE TRANSACTIONS USING BEACONS

(71) Applicant: EBAY INC., San Jose, CA (US)

(72) Inventor: Eric Byungho Min, Austin, TX (US)

(21) Appl. No.: 14/449,048

(22) Filed: Jul. 31, 2014

(51) Int. Cl. G06Q 30/06

(52) U.S. Cl. CPC G06Q 30/0623; G06Q 40/025; G06Q 50/16

(57) ABSTRACT

Systems and methods are provided for facilitating real estate transactions using beacons. One or more beacons at a property that is offered for sale by a seller may communicate with a user device of one or more potential buyers of the property when the user devices are at the property and in proximity to the beacons. The beacons may provide property information to the potential buyer and/or may receive buyer information from the user device. The buyer information may be provided to an agent device of a real estate agent at the property or to a seller device and may be processed to determine whether additional property information will be provided to the potential buyer. The property information may include marketing documentation, a survey, or seller's disclosure. The buyer information may include documents showing loan pre-qualification or contact information for the potential buyer.

### TECHNICAL FIELD

The present invention generally relates to electronic commerce and, more particularly, to systems and methods for facilitating buying and selling of real estate using beacons.

### BACKGROUND

Prospective buyers of real estate such as houses, condos, time-shares, buildings, land, or other properties often visit the property to view and obtain information about the property in order to make a decision on whether to purchase the property. These prospective buyers often desire additional information about the property from the seller or from a real estate agent. A seller or real estate agent may also desire information about multiple prospective buyers that are browsing a property in order to provide the desired information and/or differentiate between serious buyers and simple browsers such as a curious neighbor or an unqualified buyer. However, it can sometimes be difficult for a seller or agent to provide information to all prospective buyers, for a seller or agent to know what specific information would be desirable for a specific prospective buyer, and for a prospective buyer to communicate their desires, interests, and financial qualifications efficiently.

For example, while a serious buyer is browsing a property and wanting to quickly move on to view another property, a real estate agent at the property may be occupied talking to a curious neighbor with no real interest in purchasing the property and both the serious buyer and the agent/seller can miss out on an opportunity for a successful purchase/sale of the property.

It would therefore be desirable to be able to provide improved systems and methods for providing improved communications between buyers, sellers, and agents associated with real estate transactions.

### BRIEF DESCRIPTION OF THE DRAWINGS

FIG. 1 is a block diagram of an illustrative networked system suitable for implementing processes for facilitating real estate transactions, according to an embodiment.

FIG. 2 is a diagram of an illustrative property for sale having beacons, according to an embodiment.

FIG. 3 is a block diagram of an illustrative buyer device showing how property information received from a beacon at the property may be displayed to a prospective buyer, according to an embodiment.

FIG. 4 is a block diagram of an illustrative agent device showing how prospective buyer information received from a beacon at the property may be displayed to an agent, according to an embodiment.

FIG. 5 is a block diagram of an illustrative seller device showing how prospective buyer information of visitors to a property of the seller may be provided to the seller, according to an embodiment.

FIG. 6 is a flowchart of an exemplary process for receiving and processing property information with a buyer device based on communications with a beacon, according to an embodiment.

FIG. 7 is a flowchart of an exemplary process for facilitating the exchange of information associated with a real estate transaction using one or more beacons, according to an embodiment.

FIG. 8 is a flowchart of an exemplary process for receiving and processing prospective buyer information, according to an embodiment.

FIG. 9 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations provide equipment for communications with a user device of a user at the location. The equipment may include wireless communications equipment such as short range wireless communications equipment or other wireless communications equipment. The equipment may sometimes be referred to as beacon equipment or beacons. Wireless communications equipment that may be included in a beacon at a location may include Bluetooth Low Energy (BLE) beacon communications equipment, LTE Direct communications equipment, wireless local area network equipment (e.g., WiFi based equipment), cellular network equipment, global positioning system (GPS) equipment, combined cellular and UPS equipment, other radio or microwave based communications equipment, infrared communications equipment, and/or any combination thereof.

The beacons may communicate with a user device to provide the user device with location information. For example, when a user carriers their mobile device and/or a realtor device into a location such as property that is offered for sale by a seller, a beacon located at or near the location may communicate with the mobile device and/or the realtor device to provide property information and/or seller information associated with the property to the user's mobile device and/or the realtor device. If desired, the provided information may be based on the user's specific location in or around the property (e.g., in a particular room or a back yard) and/or on preferences of the user. For example, if a particular user is interested in backyard barbeques, the provided information may guide the user to the backyard of the house and inform the user of a swimming pool and barbeque in the back yard.

The beacons may also communicate with a seller device or real estate agent device to provide visitor information associated with visitors to a property. For example, when a first user such as a prospective buyer carriers their mobile device and/or a realtor device into a location such as property for sale by a seller, a beacon located at or near the location may communicate with the mobile device and/or the realtor device to receive prospective buyer information such as financial qualification information, contact information, or buyer preferences and to provide the received prospective buyer information to a second user device such as a mobile phone or other device of a real estate agent or seller at the property.

In some scenarios, the beacon and/or other computing equipment such as a server in communication with the beacon may log the prospective buyer information of multiple visitors to a property. The logged prospective buyer information may be processed (e.g., sorted and ranked) and/or provided to a seller or an agent for the seller.

Beacons may provide communication services to a user device directly, including information stored on the beacons, and/or information from a device or server corresponding to the beacon. A service provider may include one or more service locations such as properties for sale. The service location(s) may utilize short range wireless beacons to communicate with mobile user devices of the users.

The short range wireless beacons may employ, for example, BLE communications that emit a signal receivable by a user device. The communication may include an identifier for the beacon. A user device or realtor device may passively monitor for beacon communications such as BLE communications. When, for example, a user device detects a beacon signal such as a BLE signal and verifies the identifier as belonging to a particular location such as a property for sale, both the user device and the beacon may ramp up in power and establish a connection. The connection may further enable the user device to communicate with a service provider device and/or server. The beacon may be connected to a networked device at the service location, or the beacon may include network functionality to communicate with the service provider server.

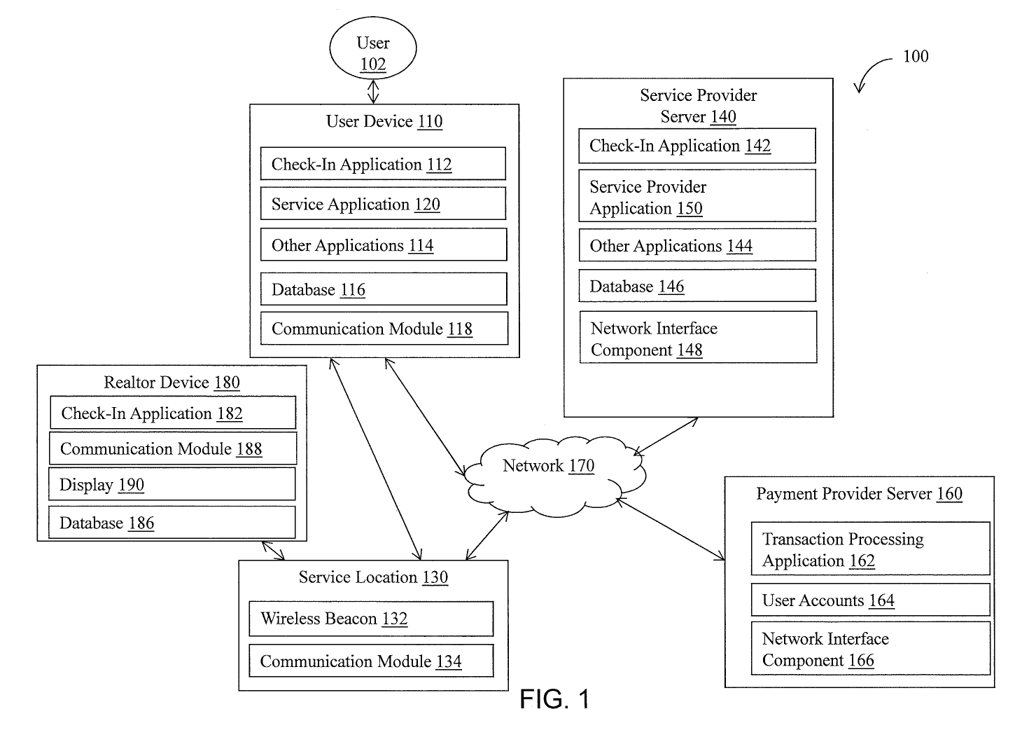

FIG. 1 is a block diagram of a networked system 100 suitable for implementing processes for facilitating real estate transactions, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 may include one or more users such as user 102, each having a user device 110 and/or a realtor device 180. User 102 may be a potential buyer of a property, a seller of a property, or an agent for a buyer or seller of a property (as examples). System 100 may also include a service location 130, a service provider server 140, and a payment provider server 160 in communication over a network 170. Each user 102 (e.g., a prospective buyer, a seller, or a real estate agent (or more generally a salesperson)), may utilize their corresponding user device 110 or a realtor device 180 (e.g., a dedicated device provided by a realtor or salesperson for sending and receiving information related to real estate transactions) to check-in to service provider server 140. Service location 130 may correspond to a property such as a house, a condominium, land, a time-share, a building, a boat, a plane, an RV, or other real property that is being offered for sale by a seller. Service provider server 140 may correspond to a general server for multiple service locations (e.g. a server for a realtor or real estate agent representing multiple properties for sale) or may be specific to only service location 130 (e.g. a server for a particular property for sale).

Check-in of a user 102 may be accomplished through a beacon 132 (e.g., a wireless beacon) at service location 130, through a social media application or website or by other check-in equipment.

User device 110, realtor device 180, service location 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software such as hardware and software configured for wired and/or wireless communication with beacon 132, realtor device 180, and service provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. The user device may be managed or controlled by any suitable processing device.

As shown in FIG. 1, user device 110 may contain a check-in application 112, a service application 120, other applications 114, a database 116, and a communication module 118. Check-in application 112, service application 120, and other applications 114 may correspond to processes, procedures, and/or applications executable by a hardware processor, for example, a software program. In other embodiments, user device 110 may include additional or different software as required.

Check-in application 112 may be used by the user 102 of user device 110 to establish a connection between user device 110 and service provider server 140. Check-in application 112 may correspond to a specific application utilized by user device 110 with service provider server 140 to complete a check-in with service provider server 140. The check-in with service provider server 140 may correspond to a process to log in to a user account of user 102 with service provider server 140. In other embodiments, the check-in may provide and/or verify an identity of user 102, including transmission of an identifier for user 102 and/or user device 110. The check-in may be completed over network 170 with service provider server 140. In such embodiments, check-in application 112 may correspond more generally to a browser application configured to communicate with service provider server 140.

Check-in application 112 may also correspond to an application available over the Internet for download from service provider server 140 and/or other server corresponding to service location 130. Check-in application 112 may utilize communications module 118 to exchange short range wireless communications with beacon 132 at service location 130 to complete a check-in process. For example, service location 130 may include infrastructure with beacon 132 to communicate with user device 110 and complete the check-in process with service provider server 140. Beacon 132 may be configured to transmit an identifier for reception by user device 110.

Check-in application 112 may execute in the background of an operating system of user device 110 and be configured to establish connections, using communication module 118 of that user device 110, with one or more beacons 132 (e.g., wireless beacons) at service location 130. The connection may be established with or without user input from user 102. For example, beacon 132 may broadcast a token, such as a universally unique identifier (UUID), for reception by check-in application 112. Check-in application 112 may utilize communication module 118 of the user device 110 to receive the token from beacon 132. If check-in application 112 acknowledges the UUID as identifying service location 130, beacon 132, and/or service provider server 140, check-in application 112 may transmit an identifier corresponding to a user 102 and/or a user device 110 back to beacon 132. Check-in application 112 may utilize communication module 118 to communicate with beacon 132 (e.g., over near field communication, Bluetooth, Bluetooth Low Energy, radio, infrared, WiFi, cellular, GPS, combined cellular and GPS, microwave, a combination thereof, or other connection). The identifier from user device 110 may include, be transmitted with, concatenated with, or otherwise bundled with the identifier received from beacon 132.

Once a connection is established with beacon 132, user device 110 may be checked-in with service provider server 140 if the user 102 of that device is not currently checked-in. The check-in process may then associate that user 102 with the beacon 132 used to check-in that user 102 and/or other wireless beacons at the service location. In such embodiments, check-in application 112 of user device 110 may utilize short range wireless communication with beacon 132, such as near field communication, Bluetooth, Bluetooth Low Energy, radio, infrared, WiFi, cellular, GPS, combined cellular and GPS, microwave, a combination thereof, or other connection. Where beacon 132 corresponds generally to service location 130 or a location in or around service location 130, user 102 may be associated with service location 130 or a particular location in or around service location 130. Thus, user 102 may be associated with the location of that beacon and/or other nearby beacons.

Check-in application 112 may receive information from service provider server 140 and/or one or more payment provider servers 160. For example, check-in application 112 may receive property information and/or seller information such as an offer price, square footage, a number of bedrooms, a number of bathrooms, a year built, a property map, a school district, photos, a length of time on the market, property features, real estate agent information (e.g., a name, a phone number, an email address, a photo, etc.) or other property or seller information. The information that is passed to check-in application 112 may be generally based on service location 130, such as an identifier of the service location, seller, realtor, or real estate agent or other information about and/or associated with service location 130. Additionally, the service provider server 140 and/or the payment provider server 160 may determine a user history, purchase history, user preferences, and/or other user information corresponding to user 102 from a user identifier transmitted to service provider server 140 during the check-in process. Thus, the information may be transmitted to user 102 based on the user history, preferences, and/or the other user information. When a user 102 is checked-in with service provider server 140 and/or payment provider server 160, service provider server 140 and/or payment provider 160 may have an identifier of user device 110 and transmit the information to user device 110 using that identifier over network 170 and/or through one or more beacons 132.

Check-in application 112 may utilize communication module 118 to pass user information to service provider server 140 and/or payment provider 160, including user preferences, user calendar information, user relationship information, user email information, user social media information, user group membership information, user family information, user team information, financial information such as loan pre-qualification information, contact information, identifiers of user 102 and/or user device 110, a request for assistance, a request for a type of assistance, etc.

Service application 120 may be used, for example, to provide a convenient interface to permit user 102 to receive, request, and/or view property information, seller information, neighborhood information, and/or other services. Service application 120 may correspond to an application specific to service location 130 and/or service provider server 140, such as an application downloadable over network 170 and/or through beacon 132. However, in other embodiments, service application 120 may correspond more generally to any application configured to receive information and/or assistance including a browser application.

In various embodiments, check-in application 112 and service application 120 may be incorporated in the same application so as to provide their respective features in one convenient application interface.

User device 110 may include other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, mobile wallet, payment method selection, and/or other applications. Other applications 114 may include browser and/or mapping applications where the functions are not provided by check-in application 112 and/or service application 120. Other applications 114 may contain software programs, executable by a processor, including a graphical user interface (GUI) configured to provide an interface to the user.

User device 110 may further include memory such as database 116 which may include, for example, identifiers such as operating system registry entries, cookies associated with check-in application 112, service application 120, and/or other applications 114, identifiers associated with hardware of user device 110, or other appropriate identifiers, such as identifiers used for payment/user/device authentication or identification. Database 116 may include user device tokens and/or encryption keys, including a public key of service location 130 and/or service provider server 140 for beacon 132. Database 116 may include identifying information for tokens enabling check-in application 112 to identify beacon 132 when receiving a corresponding token. In one embodiment, identifiers in database 116 may be used to associate user device 110 with a particular account maintained by the account provider. Database 116 may further include online account access information and/or user preference information or stored property information for multiple properties for sale.

User device 110 may include a communication module 118 adapted to communicate with beacon 132, service provider server 140, and/or payment provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, WiFi, cellular, GPS, combined cellular and GPS, microwave, near field communication devices, and/or a combination thereof. Communication module 118 may communicate directly with beacon 132 without network 170 using short range wireless communications.

Beacon 132 may check-in user 102 when the user device 110 and/or a realtor device 180 of that user is in proximity to beacon 132. Thus, beacon 132 may enable service provider server 140 and/or payment provider server 160 to associate a particular user 102 with service location 130 and/or a location within service location 130. Service location 130 may include a beacon 132 and a communication module 134. In other embodiments, service location 130 may include additional or different software and devices as required.

Beacon 132 may be maintained, for example, by service location 130 and service provider server 140 and/or one or more of payment provider servers 160. Beacon 132 may be implemented using any appropriate hardware and software configured for wireless communication with user device 110. For example, in one embodiment, beacon 132 may be implemented as a dongle device including a hardware processor and a communication module, for example, connected to device at service location 130. Thus, beacon 132 may be implemented as a device incorporated within or attached to a personal computer (PC), a smart phone, personal digital assistant (PDA), laptop computer, and/or other types of computing devices capable of transmitting and/or receiving data, such as an IPAD® from APPLE®. Beacon 132 may also act as a stand-alone device including a processor, communication module, and/or network interface component configured to communicate with user device 110 and/or service provider server 140, such as another smart phone communicating through LTE Direct. Although a single beacon is described, a plurality of beacons may be utilized and be location specific within service location 130, as discussed herein.

Beacon 132 of FIG. 1 may include processes, procedures, and/or applications, for example, a software program, executable by a hardware processor configured to interact with user devices 110. Beacon 132 may include applications for transmitting requests to establish a connection between a user device and beacon 132. Thus, beacon 132 may utilize a low energy short range wireless communication of beacon 132 to transmit requests to establish a connection with user device 110 and/or realtor device 180, including an identifier such as a Universally Unique Identifier (UUID). If user device 110 and/or realtor device 180 receive a request to establish the connection with beacon 132 and respond with a device identifier (potentially including the UUID and other information to effectuate a check-in of each device), beacon 132 may ramp up in power and create a connection between user device 110 and/or realtor device 180 and beacon 132.

Beacon 132 may transmit the request to establish the connection with beacon 132 as a short range communication (e.g. a BLE protocol communication) including a “wake up” process for check-in applications 112 of user device 110 (and/or realtor device 180) and/or a token for beacon 132 or service provider server 140. In other embodiments, the request and/or connection may utilize near field communication, radio communication, infrared communication, or Bluetooth communication, BLE communication, WiFi communication, cellular communication, GPS communication, microwave communication, and/or any suitable combination thereof. The request may be specific to each device by including information that is specific to the corresponding user 102, such as a name, identifier, or user device identifier. The information specific to user 102 may be determined from user accounts of user 102 or other information previously provided to service provider server 140. Thus, in certain embodiments, only one or more specific user devices 110 and/or realtor devices 180 will pick up and authenticate the request.

After beacon 132 receives a device identifier of user 102, beacon 132 may determine that user 102 is at or in proximity to service location 130. Beacon 132 may pass the user device identifier to service provider server 140 and/or one or more of payment provider servers 160 to complete the check-in process and associate user 102 with service location 130. As shown in FIG. 1, beacon 132 utilizes communication module 134 to pass the information to service provider server 140 and/or one or more of payment provider servers 160. However, in other embodiments, beacon 132 may utilize a network connection of beacon 132 through a communication module of beacon 132. Additionally, beacon 132 may keep a communication channel open between user device 110 and/or realtor device 180 and service provider server 140 and/or one or more of payment provider servers 160 for passing information to and from the device.

Realtor device 180 may be a dedicated device for facilitating the exchange of real estate information for potential buyers when the buyers are browsing one or more properties. For example, a realtor (e.g., a real estate agent) of a potential buyer may provide a realtor device 180 such as an electronic keychain or other portable compact device to the potential buyer to carry with them as they browse properties offered for sale. The realtor device may include a check-in application 182, a communication module 188, a database 186, a display 190, and/or other processing circuitry or electronic components suitable for receiving, transmitting, and displaying information based on communications with one or more beacons such as wireless beacons.

Realtor device 180 may be configured to communicate with beacons at the properties and to receive and display property information for the potential buyer. In some embodiments, the realtor and/or the potential buyer may load buyer information such as buyer preferences, buyer financial information, or other potential buyer information as discussed herein onto the realtor device 180 so that, when the realtor device 180 is in communication with a beacon at a property, the realtor device 180 may also provide some or all of the potential buyer information to the beacon (e.g., to be provided to a seller agent or the seller of the property). The potential buyer information may be loaded onto the realtor device from user device 110, entered manually onto the realtor device (e.g., typed), or may be loaded by a realtor computer or server (as examples). However, this is merely illustrative. If desired, all the functions described herein in connection with realtor device 180 may be performed with and/or by user device 110 and vice versa.

Realtor device 180 may also include a check-in application 182 and communication module 188 for performing check-in operations and/or other communications similar to those described herein in connection with check-in application 112 and communication module 118 of user device 110. Communication module 188 may provide realtor device 180 with near field communication capabilities, radio communication capabilities, infrared communication capabilities, or Bluetooth communication capabilities, BLE communication capabilities, WiFi communication capabilities, cellular communication capabilities, GPS communication capabilities, microwave communication capabilities, and/or any suitable combination thereof.

In various embodiments, service location 130 includes at least one communication module 134 adapted to communicate with user device 110, realtor device 180, service provider server 140, and/or one or more of payment provider servers 160. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, cellular, GPS, combined cellular and GPS, microwave, near field communication devices, and/or any combination thereof. Communication module 134 may communicate directly with user device 110 and/or realtor device 180 without network 170 using short range wireless communications.

Service provider server 140 may be maintained, for example, by a service location including one or a plurality of service locations. Generally, service provider server 140 may be maintained by anyone or any entity that establishes and/or maintains a location with services and/or products such as real estate offered to users. In this regard, service provider server 140 may include one or more applications, which may be configured to interact with user devices 110 and/or service location 130 to complete check-in processes for user devices 110. Although only one service provider server is shown, a plurality of service provider servers may be utilized. In various embodiments, the check-in and assistance features of service provider server 140 may also be offered by one or more of payment provider servers 160. Thus, all or part of the described features and processes of service provider server 140 may be incorporated within one or more of payment provider servers 160.

Service provider server 140 may include a check-in application 142, a service provider application 150, a database 146, and a network interface component 148. Check-in application 142 and service provider application 150 may correspond to processes, procedures, and/or applications, for example, a software program, executable by a hardware processor. In other embodiments, service provider server 140 may include additional or different software as required.

Check-in application 142 may correspond to processes to complete check-in with user device 110 and/or realtor device 180. Thus, check-in application 142 may correspond to the server side application of service provider server 140 configured to transmit and/or receive check-in requests from user device 110 and complete the check-in requests. A check-in request may include log-in information for a user account in database 146. Check-in may be completed by verifying the account information. However, in embodiments where a user account has not been previously established by user 102, check-in application 142 may receive other information for identifying user 102, such as user names/identifiers, user device identifiers, group identifiers, an identifier for an account with another server (e.g., a payment account/payment account identifier with payment provider server 160), or other information.

Additionally, check-in application 142 may check user 102 out of the location when user 102 leaves the proximity of beacon 132. Checking user 102 out of a location may include checking the user out of the location corresponding to a particular beacon 132.

Service provider server 140 may include service provider application 150 configured to receive information corresponding to user 102 (e.g., a user identifier, potential buyer information, and/or other user information) that is checked-in to beacon 132 through service location 130 and provide information such as a property information and/or seller information to user device 110 and/or realtor device 180.

Check-in information may correspond to one or more user accounts of user 102 with another server, such as one or more of payment provider servers 160. In such embodiments, service provider server 140 may determine user information such as a user history, financial information such as pre-qualification information, and/or user preferences from information received from a payment provider server 160. Payment provider server(s) 160 may provide information about previous purchases/visits by user 102 at the same or similar locations to service location 130 or may provide other information.

In various embodiments, service provider server 140 may include other applications 144 as may be desired in particular embodiments to provide features to service provider server 140. For example, other applications 144 may include security applications for implementing server-side security features, programmatic server applications for interfacing with appropriate application programming interfaces (APIs) over network 170, or other types of applications. Other applications 144 may contain software programs, executable by a processor, including a graphical user interface (GUI), configured to provide an interface to a user.

Service provider server 140 may include a database 146 which may include, for example, identifiers such as operating system registry entries, cookies associated with check-in application 142 and/or service provider application 150, identifiers associated with hardware of service provider server 140, or other appropriate identifiers, such as identifiers used for payment/user/device authentication or identification. Database 146 may include identifiers and/or user accounts of user 102, which may comprise an identifier for users 102, user device 110, and/or realtor device 180. In various embodiments, identifiers in database 146 may be used by a payment/credit provider, such as payment provider server 160, to associate user 102 with a particular account maintained by a payment provider server 160. For example, an identifier for a payment account with a payment provider server 160 may be stored with a user account and/or identifiers of users 102 in database 146. In other embodiments, a user account stored in database 146 may include a shared identifier with the payment account with a payment provider server 160.

In various embodiments, service provider server 140 includes at least one network interface component 148 adapted to communicate with user devices 110, service location 130, and/or payment provider servers 160 over network 170. In various embodiments, network interface component 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, cellular, GPS, combined cellular and GPS, microwave, near field communication devices, and/or any combination thereof.

Payment provider server 160 may include a payment provider server maintained, for example, by an online payment service provider, which may provide user account and payment services on behalf of user 102 and other users. In this regard, a payment provider server 160 includes one or more processing applications, which may provide payment for items using a user account with that payment provider server 160. In one example, payment provider server 160 may be provided by PAYPAL®, Inc. of San Jose, Calif., USA. Although payment provider server 160 is described as separate from service provider server 140, it is understood that payment provider server 160 may include services offered by service provider server 140 and vice versa.

Payment provider server 160 may include a transaction processing application 162, a database of user accounts 164, and a network interface component 166. Transaction processing application 162 may correspond to processes, procedures, and/or applications, for example, a software program, executable by a hardware processor. In other embodiments, payment provider server 160 may include additional or different software as required.

Transaction processing application 162 may be configured to receive information from one or more user devices 110, realtor devices 180, and/or service provider server 140 for transfer of information and/or processing and completion of financial transactions. Transaction processing application 162 may include one or more applications to process financial transactions between user devices 110 and/or service provider server 140. Financial transactions may include financial information corresponding to user debit/credit card information, checking account information, escrow account information, a user account (e.g., payment account with a payment provider server 160), or other payment information. Transaction processing application 162 may complete the financial transaction for the purchase request by providing payment to service provider server 140. In various embodiments, transaction processing application 162 may provide transaction histories, including receipts, to user device 110 in order to provide proof of purchase for an item and/or service. Transaction processing application 162 may also provide the transaction histories to service location 130 for use in pick-up/delivery of the item and/or service.

Additionally, a payment provider server 160 includes user accounts 164. As previously discussed, user 102 may establish one or more user accounts with a payment provider server 160. User accounts 164 may include user information, such as a name, an address, a birthdate, payment/funding information, additional user financial information such as loan pre-qualification information, and/or other desired user data.

In various embodiments, each payment provider server 160 may include at least one network interface component 166 adapted to communicate with user device 110, service location 130, and/or service provider server 140 over network 170. In various embodiments, network interface component 166 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), infrared (IR), BLE, cellular, GPS, combined cellular and GPS, microwave, and/or near field communication devices, and/or any combination thereof.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

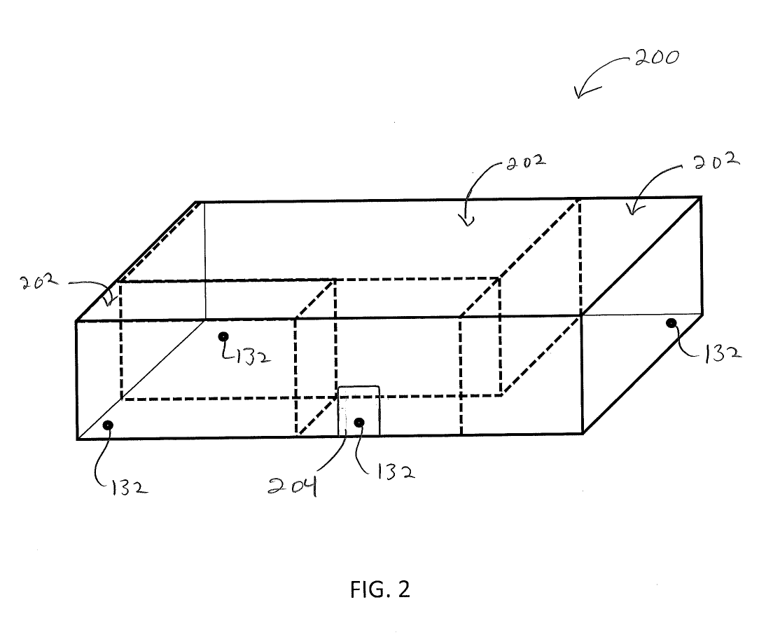

FIG. 2 is a diagram of an exemplary property for sale. As shown in FIG. 2, property 200 (e.g., a house, a condominium, a time-share, an apartment building, a warehouse, a factory, a boat, a plane, an RV, or other real property) that is for sale (e.g., by a seller) may be provided with one or more beacons 132 (e.g., wireless beacons). As shown, a beacon 132 may be located at or near an entrance 204 such as a doorway to the property. When a prospective buyer approaches and/or passes through the entrance 204, the beacon 132 at the entrance 204 may selectively pass information from the seller to a user device or realtor device in possession of the prospective buyer (e.g., marketing documentation, a survey, or seller's disclosure). The information passed from the seller to each prospective buyer may be selected based on preferences of that buyer and/or information broadcasted by that buyer. The user device or realtor device in possession of the user may also selectively pass information from the prospective buyer to the seller (e.g., documents showing loan pre-qualification, contact information, etc.).

Property 200 may include several subdivisions such as portions 202. For example, property 200 may be a house for sale that includes several rooms 202. In some embodiments, one or more rooms 202 may be provided with individual beacons 132. In this way, the location of a potential buyer within the property can be determined and specific information for each room or other portion of the property can be provided to the potential buyer when the potential buyer is in that room.

For example, a potential buyer may walk into a house and be provided with marketing materials for that house and an agent such as a seller's agent may be notified that the potential buyer has arrived and may be provided with information of the potential buyer. When the potential buyer walks to a particular room such as a living room, the potential buyer may receive information pointing out features of the living room (e.g., a fireplace) and/or the seller's agent may be notified that the potential buyer is in the living room so that the agent can go to and meet the potential buyer. A realtor server or payment provider server may also obtain preferences of the potential buyer and guide the potential buyer (e.g., using communications between beacons 132 and a device of the buyer to create a virtual guide path) to particularly interesting features of the property based on the obtained preferences. For example, if the potential buyer has an interest in fireplaces (e.g., based on a user-provided preference or a previous purchase by the user of a fireplace, firewood, camping equipment, etc.), the potential buyer may be guided to the living room using beacons 132.

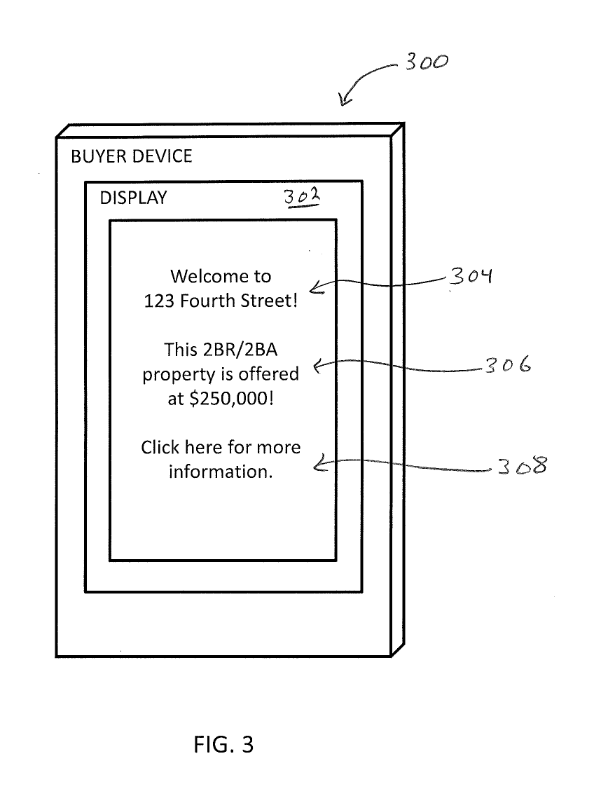

Property information may be provided to a potential buyer using a display of buyer device such as a user device (e.g., a mobile phone or tablet) or a realtor device in possession of the potential buyer. FIG. 3 is a diagram of an exemplary buyer device showing how property information may be provided to the potential buyer using the display of the buyer device.

As shown in FIG. 3, a buyer device 300 may include a display 302. Buyer device 300 may be a smart phone or a tablet of a potential buyer of a property or may be a realtor device provided to the potential buyer by a realtor. When a potential buyer arrives at a property for sale, display 302 of buyer device 300 may be used to provide the potential buyer with a welcome message 304, property information 306, and, if desired, a link 308 to additional information. Welcome message 304 may include text such as “Welcome to 123 Fourth Street!” that includes an address of the property and/or other suitable information for welcoming a potential buyer.

Property information 306 may include property details such as a number of bedrooms, a number of bathrooms (e.g., 2BR/2BA to indicate that the property is a 2 bedroom, 2 bathroom house), a square footage, and/or other property features and may include property sale information such as a sale price (e.g., $250,000) or other sale information (e.g., an interest rate offered by a lender for the property, etc.). For example, property information 306 may include text such as “This 2BR/2BA property is offered at $250,000”. A link 308 to additional information may also include text such as “Click here for more information.” or other suitable text.

When clicked, link 308 may provide the potential buyer with additional property information such as a marketing document, a survey, a seller's disclosure, an appraisal, school district information, seller's agent information, and/or other property information or seller information. Welcome message 304, property information 306, and additional information associated with link 308 may be generated by buyer device 300 using information provided by a beacon at the property or may be generated and provided by the beacon. Link 308 and/or information provided by link 308 may be selectively provided to some potential buyers based on buyer information received from the buyer device. For example, a seller's disclosure may only be provided to well-qualified buyers while only marketing information may be provided to under-qualified buyer or buyers who do not provide any or enough buyer information.

In one embodiment, link 308 may only be provided while the buyer device is in communication with a beacon at the property. For example, because a seller may not typically wish to provide potential buyers with a disclosure until an offer is made and accepted, but may wish to incentivize well-qualified buyers to make an offer, the seller may allow a beacon at the property to provide access to a disclosure (e.g., via link 308) for a limited time while the potential buyer is at the property. Device 300 may remove link 308 and any associated information when the potential buyer leaves the property.

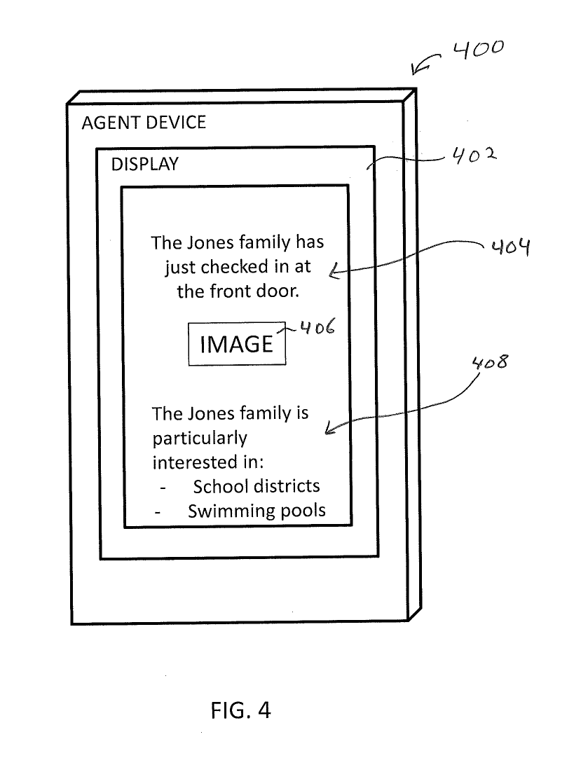

While the potential buyer is at the property, information of the potential buyer may be provided to the seller or an agent for the seller using, for example, an agent device in communication with a beacon at the property. FIG. 4 is a diagram of an exemplary agent device showing how potential buyer information may be provided to an agent using the display of the agent device.

As shown in FIG. 4, an agent device 400 may include a display 402. Agent device 400 may be a smart phone or a tablet of a real estate agent for the seller or may be a dedicated device for facilitating exchange of information associated with real estate transactions. When a potential buyer arrives at a property for sale, display 402 of agent device 400 may be used to provide the agent with an arrival notification 404, an image 406 of the potential buyer, preferences 408 of the buyer, and/or other information (e.g., loan pre-qualification information) or links to other information.

Arrival notification 402 may include text such as “The Jones family has just checked in at the front door.” that includes an identifier such as a name of one or more potential buyers, a current location of the potential buyer(s) and/or other suitable information that may be useful for an agent in welcoming a potential buyer.

Image 406 may include an image of the potential buyer or buyers, an image of a buyer's agent or other suitable images. Preferences 408 may include property preferences for the potential buyer(s) such as a school district preference, a preference for swimming pools or other preferences. Preferences 408 may be provided to an agent on display 402 using text such as “The Jones family is particularly interested in:—School districts—Swimming pools” or other suitable text or images that may be helpful to an agent for selling the property to the potential buyer.

Potential buyer information received from buyer devices at a property can be stored, logged, processed and/or sorted and the potential buyer information and/or processed potential buyer information can be provided to a seller so that the seller can review and/or rank potential buyers. Property information received from each of several properties can be stored by a user device and organize for later comparison and review by the potential buyer.

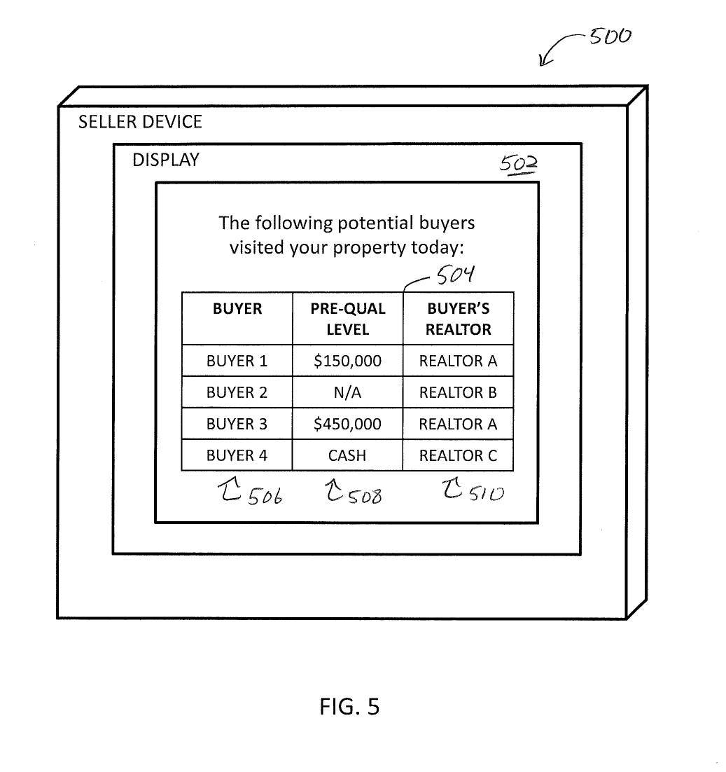

FIG. 5 shows an example of a seller device 500 having a list of potential buyers that have visited a property of the seller. As shown in FIG. 5, a display 502 of seller device 500 may be used to display information associated with each of several potential buyers. In the example of FIG. 5, potential buyer information is presented in a table 504 having a buyer identifier (“BUYER”) column 506, a pre-qualification level (“PRE-QUAL LEVEL”) column 508, and a buyer's realtor (“BUYER'S REALTOR”) column 510. However, this is merely illustrative. In other embodiments, potential buyer information may be presented in other formats and/or other potential buyer information such as contact information for the buyers may also or alternatively be provided.

In the example of a tabular presentation, a table 504 may include an identifier of each potential buyer (e.g., BUYER 1, 2, 3, and 4) a pre-qualification level (e.g., a pre-qualified loan amount such as $150,000 for BUYER 1, or $450,000 for BUYER 3, a lack of a pre-qualification such as a not applicable (N/A) symbol for BUYER 2, or a “CASH” indicator for BUYER 4 showing that a buyer is able to pay cash for the property), and a realtor or real estate agent identifier (e.g., REALTOR A, B, or C). The information provided in table 504 (for example) may be used to rank potential buyers even before any offers for a property are made and can assist a seller or agent in gauging interest in and possibly adjusting the price for a property for sale.

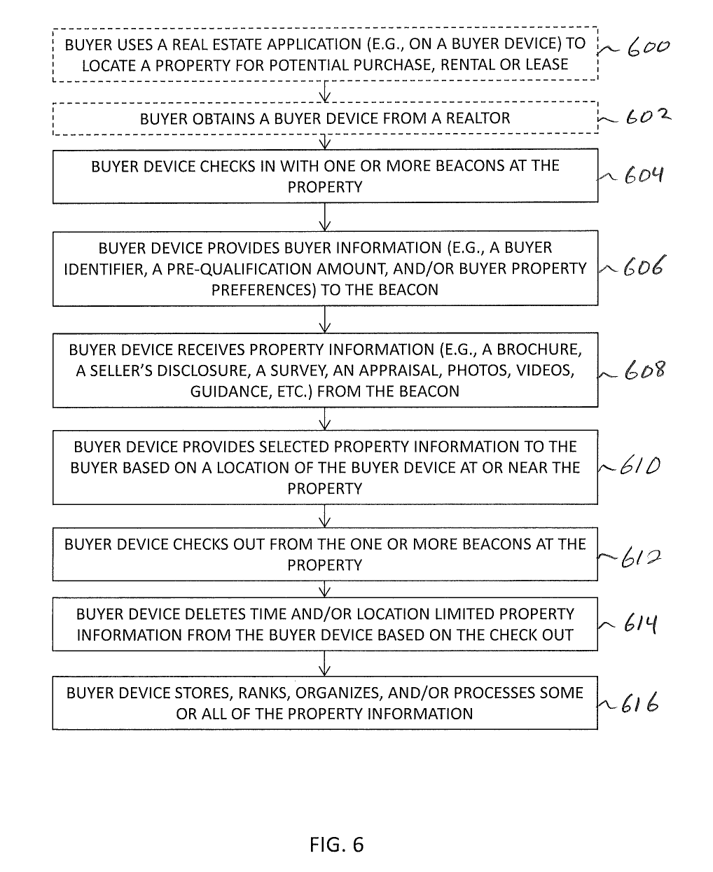

FIG. 6 is a flowchart of an exemplary process that may be performed by a buyer device of a potential buyer of a property for facilitating the exchange of information between a buyer and a seller or agent using beacons, according to an embodiment.

The process of FIG. 6 may be initiated with one or more optional actions by the potential buyer such as actions associated with optional steps 600 and 602.

At step 600, a buyer may use a real estate or property application (e.g., an application running on a buyer device such as a smartphone or other computing device of the buyer) to locate a property for potential purchase, rental or lease. For example, the potential buyer may use a web browser or real estate application running on a smartphone to browse real estate listings and choose one or more properties of interest to visit. A real estate application may obtain global positioning system (GPS) information from the smartphone and provide recommended properties to the potential buyer based on the GPS information.

At step 602, the buyer may optionally obtain an additional buyer device such as a dedicated realtor device from a realtor. However, the actions described in connection with steps 600 and 602 are merely illustrative. If desired, the buyer can proceed without a realtor device and/or the buyer can determine one or more properties of interest in other processes such as exploring a neighborhood in person, through recommendations of an agent, etc. Once the buyer has determined a property to visit, the buyer may proceed to the property with a buyer device.

At step 604, the buyer device may check in with one or more beacons at the property as described herein.

At step 606, the buyer device may provide buyer information (e.g., a buyer identifier, a pre-qualification amount for a loan, and/or buyer property preferences) to the beacon.

At step 608, the buyer device may receive property information (e.g., a brochure for the property, a seller's disclosure, a survey, an appraisal, photos, videos, guidance, etc.) from the beacon.

At step 610, the buyer device may provide selected property information to the buyer based on a location of the buyer device at or near the property. For example, the buyer device may display welcome and/or introductory information to the buyer when the buyer is near the entrance (or entering the property for the first time) or the buyer device may display information specific to a particular room of a house when the buyer is in or approaching that room.

At step 612, the buyer device may check out from the one or more beacons at the property (e.g., when the buyer leaves a room or particular area associated with a particular beacon and/or when the buyer leaves the property). The buyer device may check out from the one or more beacons when the buyer device leaves the vicinity of the beacons.

At step 614, the buyer device may delete time and/or location limited property information from the buyer device based on or responsive to the check out. For example, if a seller (via a beacon) has provided the buyer with access to the seller's disclosure documents while the buyer is at the property, but does not wish to provide permanent access to the disclosure documents, the buyer device may execute deletion instructions to remove the provided disclosure documents when the buyer device is removed from the property in accordance with the seller's desires.

At step 616, the buyer device may store, rank, organize, and/or process some or all of the received property information. For example, the buyer device may organize the provided property information and additional property information associated with additional properties according to price, location, school district, and/or other buyer-provided or learned preferences of the buyer.

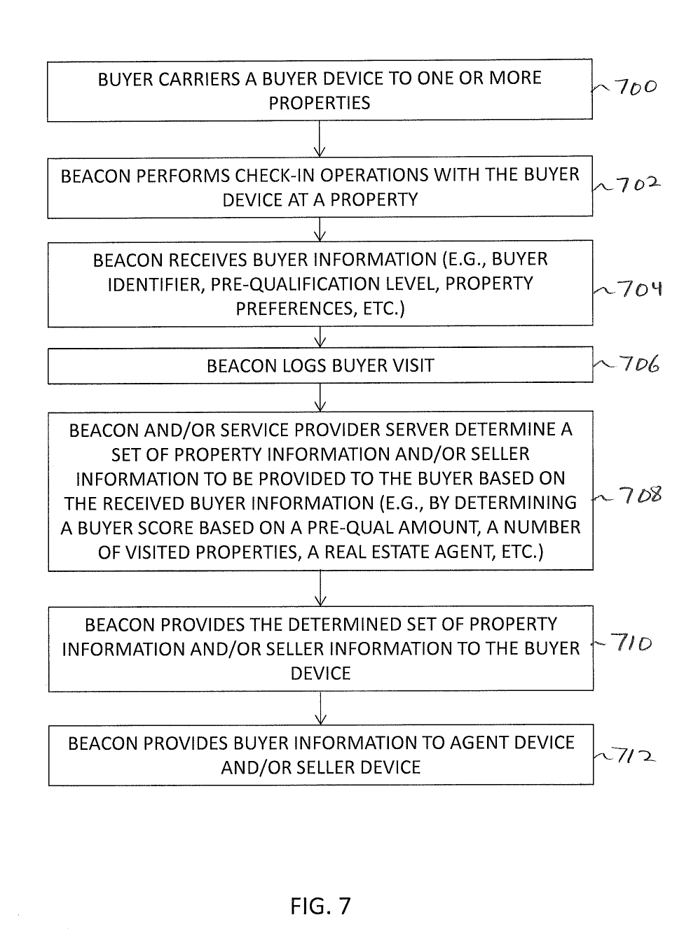

FIG. 7 is a flowchart of an exemplary process that may be performed by a beacon at a property for facilitating the exchange of information between a buyer and a seller or agent, according to an embodiment.

At step 700, a potential (prospective) buyer of may carry a buyer device such as a mobile user device or a dedicated realtor device to one or more properties that the buyer may consider purchasing.

At step 702, a beacon such as a wireless beacon, may perform check-in operations with the buyer device at a property where the beacon is located. Check-in operations may be performed as described, for example, herein in connection with FIG. 1.

At step 704, the beacon may receive buyer information (e.g., a buyer identifier, a pre-qualification level for a loan, property preferences, etc.) from the buyer device. The loan pre-qualification level may be a maximum pre-qualification amount for the potential buyer or may be a pre-qualification level set for disclosure by the potential buyer (e.g., a level that is below the maximum pre-qualification level for the potential buyer so that the potential buyer can control the information that is provided to the seller or seller's agent).

At step 706, the beacon may log the buyer visit. The beacon may log the buyer visit by storing some or all of the received buyer information along with buyer information of other potential buyers that have visited the property and/or providing some or all of the received information to a service provider server or payment provider server for logging.

At step 708, the beacon and/or a service provider server (or payment provider server) associated with the beacon may determine a set of property information and/or seller information to be provided to the buyer based on the received buyer information (e.g., by determining a buyer score based on a pre-qualification amount, a number of visited properties, a real estate agent, etc., and determining which property information to provide based on the buyer score). For example, a potential buyer that is pre-qualified for a loan for an amount sufficient to purchase the property may be associated with a higher buyer score than a potential buyer with a low pre-qualification amount or without pre-qualification.

As another example, a potential buyer that has visited multiple properties on the same day as visiting the property at which the beacon is located may be determined to be a more serious buyer than a potent buyer that visited only that property and may therefore be associated with a relatively higher buyer score. As another example, a potential buyer that is associated with a trusted seller agent may be associated with higher buyer score than a potential buyer without a buyer's agent. A potential buyer with a relatively higher buyer score may be provided with more property information that a relatively lower buyer score buyer according to an embodiment.

Determining the set of property information and/or seller information to be provided to the buyer may also include determining the set of property information and/or seller information based on preferences of the buyer. For example, one prospective or potential buyer may receive different information than another prospective or potential buyer based on buyer preferences of those buyers. For example, a first potential buyer may be an elderly buyer and may be provided with information that is focused on first floor traits of the property, while a second potential buyer may be known to be interested in high tech and entertainment features and may be provided with information that is focused on wired systems, entertaining areas, etc.

At step 710, the beacon may provide the determined set of property information and/or seller information to the buyer device as discussed herein.

At step 712, the beacon may provide buyer information received from the buyer device to an agent device and/or a seller device as described herein.

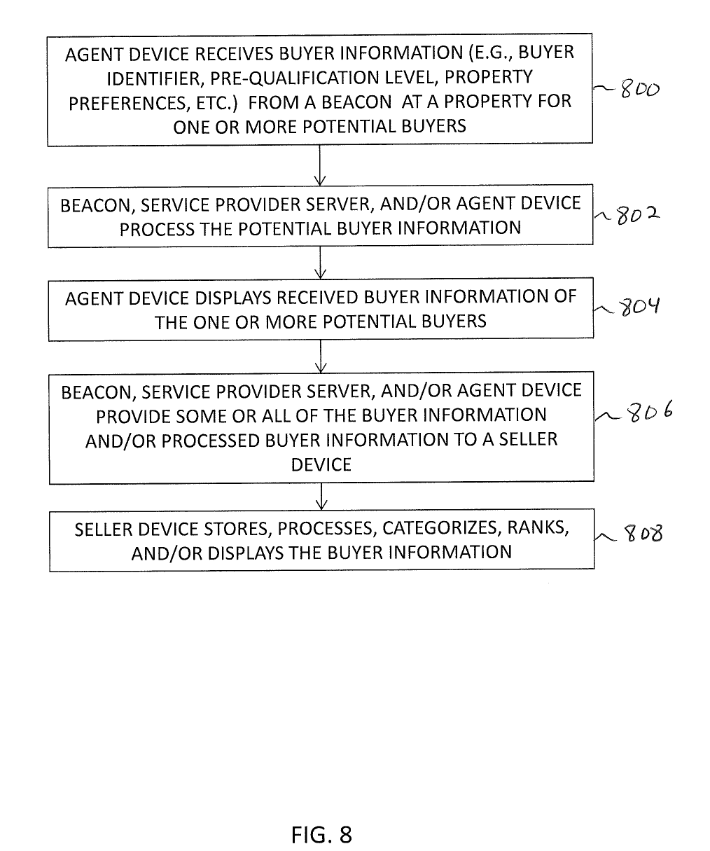

FIG. 8 is a flowchart of an exemplary process that may be performed by an agent device and/or other devices for facilitating the exchange of information between a buyer, seller, and/or agent in connection with a real estate transaction, according to an embodiment.

At step 800, an agent device such as a mobile phone or tablet of a real estate agent for a seller may receive buyer information (e.g., a buyer identifier, pre-qualification level, property preferences, etc.) from a beacon at a property for one or more potential buyers. For example, the agent device may receive potential buyer information each time a potential buyer enters the property.

At step 802, a beacon, a service provider server, and/or the agent device (and/or a payment provider server) may process the potential buyer information. Processing the potential buyer information may include ranking the potential buyer and additional potential buyers based on various criteria as discussed herein such as loan pre-qualification amounts or levels, etc. For example, the ranking may include determining a buyer score for each potential buyer and ranking the potential buyers based on the buyer scores.

At step 804, the agent device may display some or all of the received buyer information of the one or more potential buyers. For example, the agent device may display buyer information as described above in connection with FIG. 4.

At step 806, the beacon, the service provider server, and/or the agent device (and/or a payment provider server) may provide some or all of the buyer information and/or the processed buyer information to a seller device. For example, a beacon may provide unprocessed received buyer information to a seller device (e.g., directly or via a service provider server, agent device, or payment provider server) and/or the beacon, service provider server, agent device, or payment provider server, may provide processed buyer information such as a ranked list of potential buyers to the seller device.

At step 808, the seller device may store, process, categorize, rank, and/or display the buyer information to a seller or seller's agent. For example, the seller device may perform a ranking of multiple potential buyers to determine a ranked list or may receive a ranked list of multiple potential buyers from a beacon or server and may display the ranked list (e.g., in a table as described above in connection with FIG. 5).

It should be appreciated that one or more of the processes and steps described in connection with FIGS. 6, 7, and 8 may be performed in any suitable order, omitted, and/or repeated any suitable number of times for facilitating the exchange of buyer, seller, and property information for facilitating real estate shopping and transactions. It should also be appreciated that, while the description focuses on real estate and real estate agents, different embodiments using the various features described herein can include transactions involving other property for sale, such as boats, planes, and RVs, and sales agents/sellers facilitating the transactions using corresponding devices.

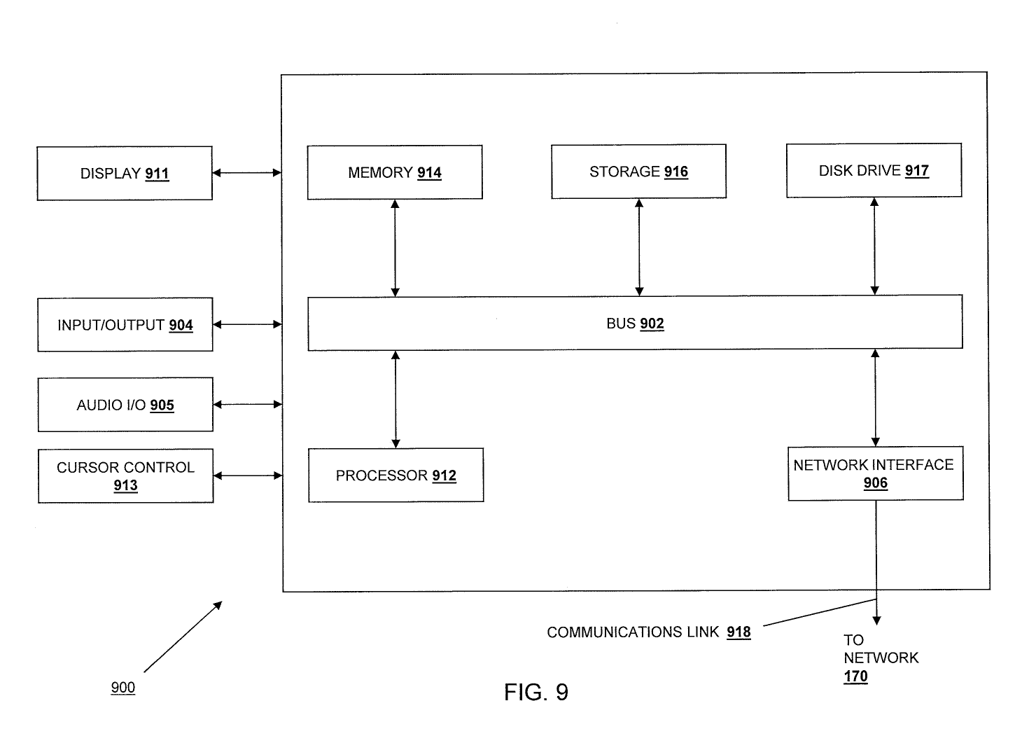

FIG. 9 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 900 in a manner as follows.

Computer system 900 includes a bus 902 or other communication mechanism for communicating information data, signals, and information between various components of computer system 900. Components include an input/output (I/O) component 904 that processes a user action, such as selecting keys from a keypad/keyboard, selecting one or more buttons, image, or links, and/or moving one or more images, etc., and sends a corresponding signal to bus 902. I/O component 904 may also include an output component, such as a display 911 and a cursor control 913 (such as a keyboard, keypad, mouse, etc.). An optional audio input/output component 905 may also be included to allow a user to use voice for inputting information by converting audio signals. Audio I/O component 905 may allow the user to hear audio. A transceiver or network interface 906 transmits and receives signals between computer system 900 and other devices, such as another user device, a merchant device, or a service provider server via network 170. In one embodiment, the transmission is wireless, although other transmission mediums and methods may also be suitable. One or more processors 912, which can be a micro-controller, digital signal processor (DSP), or other processing component, processes these various signals, such as for display on computer system 900 or transmission to other devices via a communication link 918. Processor(s) 912 may also control transmission of information, such as cookies or IP addresses, to other devices.

Components of computer system 900 also include a system memory component 914 (e.g., RAM), a static storage component 916 (e.g., ROM), and/or a disk drive 917. Computer system 900 performs specific operations by processor(s) 912 and other components by executing one or more sequences of instructions contained in system memory component 914. Logic may be encoded in a computer readable medium, which may refer to any medium that participates in providing instructions to processor(s) 912 for execution. Such a medium may take many forms, including but not limited to, non-volatile media, volatile media, and transmission media. In various embodiments, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. A non-transitory computer-readable medium may include instructions which, in response to execution by a computer system, cause the computer system to perform some or all of one or more methods as described herein. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing information about a property;
one or more beacons at the property; and
one or more hardware processors in communication with the hardware memory and the one or more beacons and configured to:
determine that a user that is a potential buyer of the property is at the property based on communications between a user device of the user and the one or more beacons;
receive user information from the user device via the one or more beacons; and
provide at least a portion of the information about the property to the user device via the one or more beacons.

2. The system of claim 1, wherein the portion of the information about the property includes marketing information for the property.

3. The system of claim 2, wherein the user information includes loan pre-qualification information of the user.

4. The system of claim 3, wherein the one or more hardware processors are configured to provide the portion of the information about the property to the user device based on the user information.

5. The system of claim 4, wherein the one or more hardware processors are further configured to provide, based on the loan pre-qualification information, an additional portion of the information about the property to the user device.

6. The system of claim 5, wherein the additional portion of the information about the property comprises a seller's disclosure.

7. The system of claim 3, wherein the one or more hardware processors are configured to provide the portion of the information by determining a buyer score based on the loan pre-qualification information and providing, based on the buyer score, only the marketing information to the user device.

8. The system of claim 1, wherein the portion of the information about the property includes guidance information generated based on a location of the user and at least one user preference.

9. The system of claim 1, further comprising the user device, wherein the user device comprises an additional processor configured to organize the provided information about the property and additional property information associated with additional properties.

10. The system of claim 1, further comprising an agent device of a real estate agent for a seller of the property, wherein the agent device is configured to receive at least a portion of the user information from the one or more beacons.

11. The system of claim 1, further comprising a seller device of a seller of the property, wherein the seller device is configured to receive at least a portion of the user information and additional user information associated with additional users that have visited the property.

12. A method, comprising:
storing, with a hardware memory, information about a property;
determining, with one or more hardware processors in communication with the hardware memory and with one or more beacons at the property, that a user that is a potential buyer of the property is at the property based on communications between a user device of the user and the one or more beacons;
receiving, with the one or more hardware processors, user information from the user device via the one or more beacons; and
providing, with the one or more hardware processors, at least a portion of the information about the property to the user device via the one or more beacons.

13. The method of claim 12, further comprising providing at least a portion of the user information to an agent device of an agent of a seller of the property.

14. The method of claim 13, wherein the portion of the user information includes an identifier of the user.

15. The method of claim 13, wherein the portion of the user information includes an image of the user.

16. The method of claim 13, wherein the portion of the user information includes property preferences of the user.

17. The method of claim 12, further comprising providing a welcome message, including the portion of the information about the property, to the user responsive to the determining.

18. A non-transitory computer-readable medium comprising instructions which, in response to execution by a computer system, cause the computer system to perform a method comprising:
storing information about a property;
determining that a user that is a potential buyer of the property is at the property based on communications between a user device of the user and one or more beacons at the property;
receiving, at one of the one or more beacons, user information from the user device via the one or more beacons; and
providing, with the one of the one or more beacons, at least a portion of the information about the property to the user device.

19. The non-transitory computer-readable medium of claim 18, wherein the method further comprises guiding the user through the property based on a location of the user determined using the one or more beacons.

20. The non-transitory computer-readable medium of claim 18, wherein the one or more hardware processors are configured to determine that the user that is the potential buyer of the property is at the property based on the communications between the user device of the user and the one or more beacons when the user device of the user is in proximity to at least one of the one or more beacons and in communication with the at least one of the one or more beacons using one of near field communication, radio communication, infrared communication, Bluetooth communication, cellular communication, global positioning system communication, and Bluetooth low energy communication.
